(19) United States
(12) Patent Application Publication
(10) Pub. No.: US 2003/0084835 A1
(43) Pub. Date: May 8, 2003

(54) Structure of a flagpole and its holder

(76) Inventor: Huang Cheng Chao, Tau-Yuan Hsien (TW)

Correspondence Address: DOUGHERTY & TROXELL, SUITE 1404, 5205 LEESBURG PIKE, FALLS CHURCH, VA, 22041, US

(21) Appl. No.: 09/985,209

(22) Filed: Nov. 2, 2001

(51) Int. Cl. G09F 17/00

(52) U.S. Cl. 116/173; 116/209; 116/28 R; 40/591

(57) ABSTRACT

The present invention is a structure of flagpole and its holder: on top of the flagpole is a fixing device for holding the flag; a joint between the flagpole and holder for connection; at one side of the holder a hook shaped plate to hang the holder onto an object.

### BRIEF OF THE INVENTION

The present invention provides a structure of flagpole and its holder, especially for industrial purposes such hanging on the car windows, placing on a flat surface or plug into any object.

### BACKGROUND OF THE INVENTION

In cases of collective activities, parties and parades flags are, besides the chest band and hand slogan, the most remarkable presentation in particular the flags hanging on the vehicle body flying with the wind drawing the most of the eye catching propaganda effects. Flags can be put on the outside of buses and trucks while small vehicles have some limits. The most common way is to tie the flag on the antenna which often will produce not so desirable result if the flag becomes loose or bent by the high speed of wind when driving. Or people tie the flags with longer poles to the antenna or the rear view mirror which also will cause the antenna to bend or break due to high speed of wind when driving. For the rear view mirror tying, this will affect the driver view and cause safety problems.

### TECHNICAL MEASURES OF THE INVENTION

The present invention provides a structure of flagpole and its holder, especially for hanging on the car windows, placing on a flat surface thus having a wide range of practical uses.

### PURPOSE OF THE INVENTION

The purpose of the present invention is to provide a device of flagpole and its holder combined or separated as the case may require for a wide range of uses such as hanging on the car windows, placing on a flat surface or plug into any object.

### BRIEF EXPLANATION OF THE DRAWINGS

FIG. 1 is the three-space decomposed drawing.

FIGS. 2A to C is the assembly process drawing.

FIG. 3 is the three-space assembly drawing.

FIG. 4 is the effectuation drawing on a car window.

### EMBODIMENTS

The following detailed elaboration will make the purpose and structure of the present invention much clear with the drawings to illustrate the structures of selected examples.

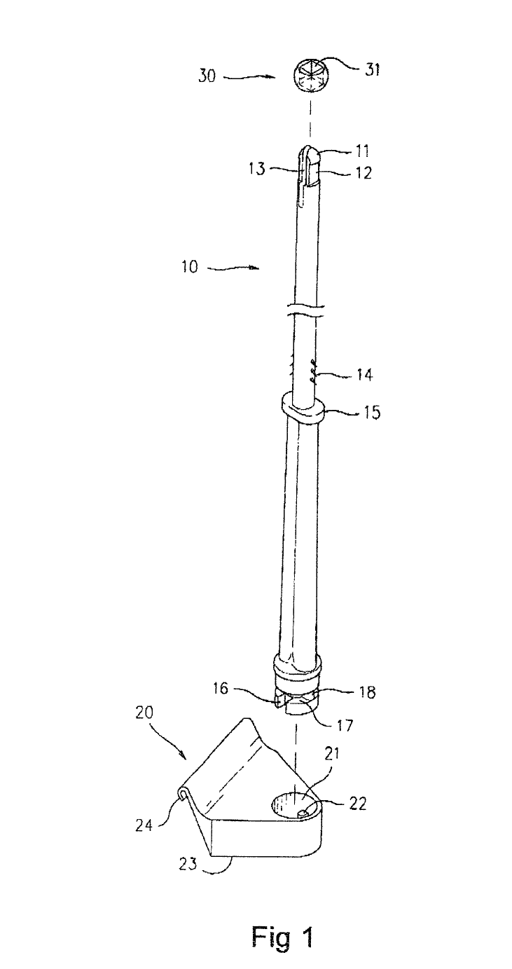

Please refer to FIG. 1 to FIG. 3 for the present invention which shows the flagpole 10 and holder 20. On top of the flagpole 10, a fixing device 30 is designed which has a hole 31 in the shape of a ball. The hole 31 will travel through the convex 11 to clamp onto the concave 12 under the convex 11 on top of the flagpole 10 for the upper part of the flag 40 to go in. An opening 13 is made along with the flagpole 10 between the concave 12 and convex 11 on top of the flagpole 10 to provide certain flexibility for easy in and out of the ball shape fixing device 30. Reversed hooks 14 are made at the middle section of the flagpole 10 to take in the inner side of the flag 40 in prevention of flag sliding at the bottom. A convex edge 15 is set at the proper point at the center part of the flagpole 10 to stop the bottom of the sleeve 41 and flag 40 down to the point.

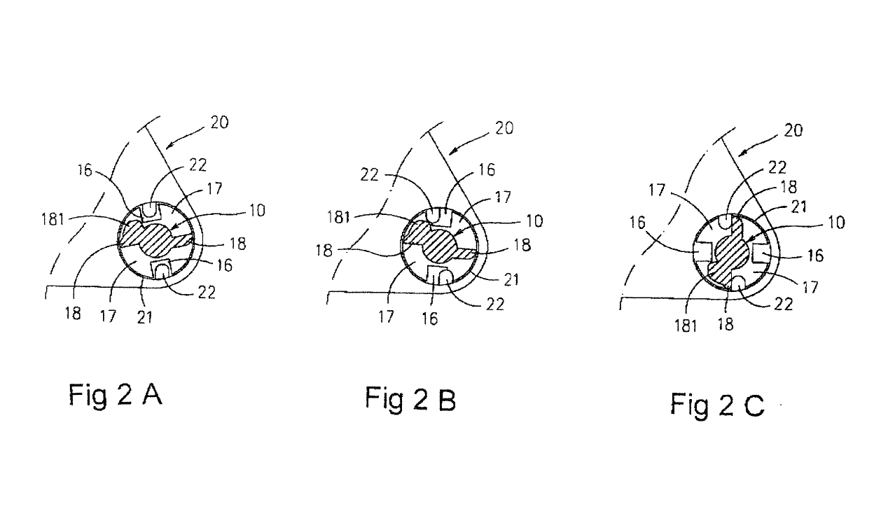

A joint device between the flagpole 10 and the holder 20 is made, as shown in the drawings, which has a concave 21 on the holder 20 and two opposite convex 22 in the concave 21; further more there are two concave grooves 16 corresponding the convex 22 at the bottom of the flagpole 10, two ring grooves 17 above the concave grooves 16, two stoppers 18 at the proper location of ring grooves 17. As shown in FIG. 2, the concave grooves 16 of the flagpole 10 will insert into the convex structure 22 of the holder 20 to enter the ring groove 17, turn the flagpole 10, stop at the stopper 18, thus convex 22 finally clamp into the ring groove 17 for the completed connection of the flagpole 10 and the holder 20. An additional stopper 181 may be set up on one of the stoppers 18 with the aim that the flagpole 10 can only make single direction turning, i.e. as shown in the FIG. 2, the flagpole 10 will be stopped by stopper 181 and allowed to make single direction turning only.

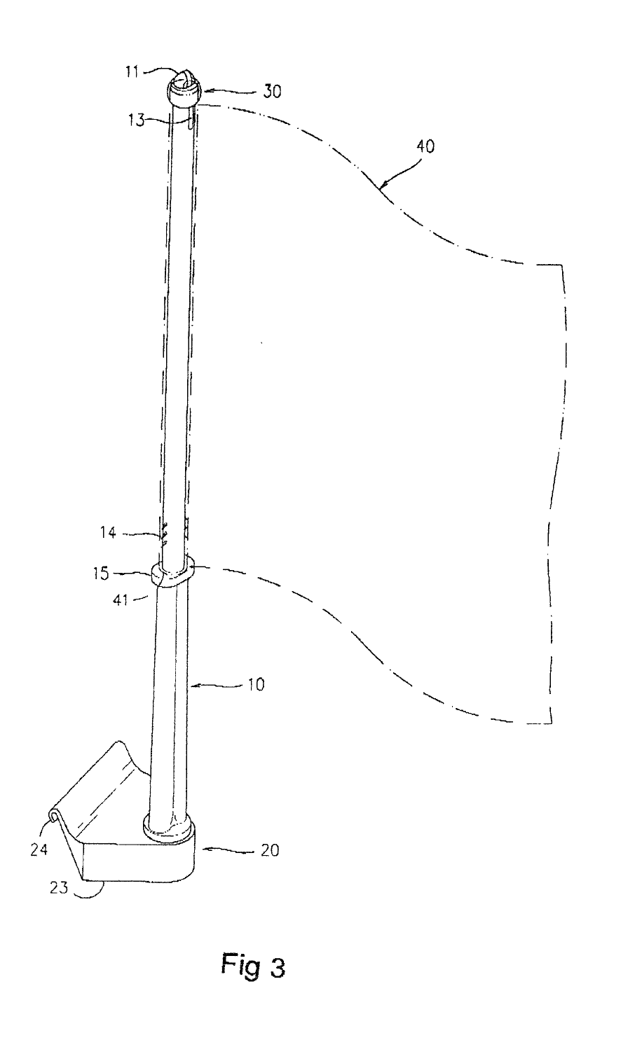

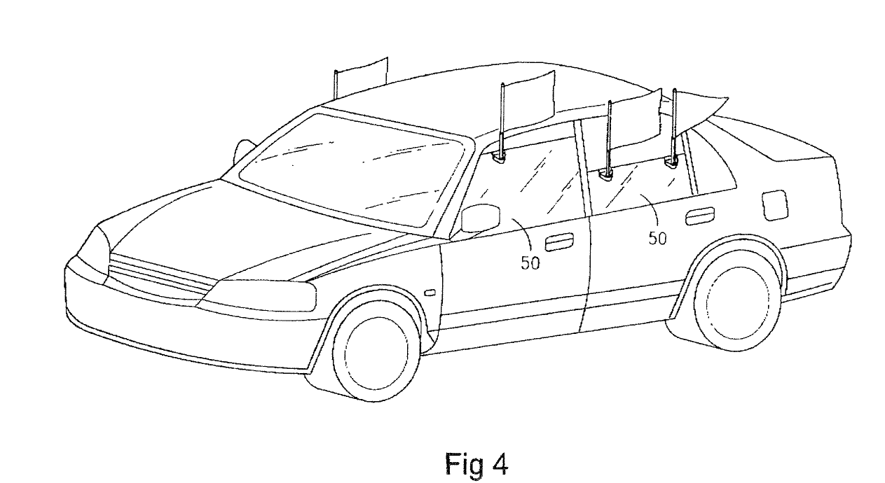

As shown in FIG. 3, the holder 20 has a flat bottom 23, therefore the present invention can be placed on any flat surfaces. The flagpole 10 may be separated from the holder 20 for direct holding. With the hook structure 24 on one side of the holder 20, the holder 20 can be hooked on an object. As shown in FIG. 4, the present invention can be hooked onto car windows 50 at proper place; all 4 windows are suitable for a number of flags in different styles. The position and height may be adjusted by car windows 50.

### DRAWING REFERENCE NUMBER

10 flagpole

11 convex structure

12 concave structure

13 opening

14 reversed hook

15 convex edge

16 concave groove

17 ring groove

18 stopper

181 stopper convex

20 holder

21 concave hole

22 convex part

23 flat bottom

24 hook structure

30 fixing device

31 penetrating hole

40 flag

50 car window

What is claimed is:

1. A structure of flagpole and its holder, which is designed for holding a flag; on top of the flagpole is a fixing device for holding the flag; a joint is between the flagpole and the holder for connection; a hook shaped plate is at one side of the holder to hang the holder onto an object.

2. The structure of flagpole and its holder of claim 1, wherein said hooks are at the center part of the flagpole for catching the inner side of a flag.

3. The structure of flagpole and its holder of claim 1, wherein said joint between the flagpole and its holder characterized by: a concave is at the proper point on the holder base; two corresponding convex are in the concave structure and two concave grooves are at the bottom of the flagpole corresponding the convex; a ring grooves is at the upper part of the concave groove; two stoppers are at the proper place in the ring groove; the concave of the flagpole join in the convex structure of the holder to enter ring groove; finally by turning the flagpole to meet the stopper and clamp the convex structure into the ring groove for connection.

4. The structure of flagpole and its holder of claim 1, wherein the bottom of the holder is flat.

5. The structure of flagpole and its holder of claim 1, wherein said fixing device is on top of the flagpole; there is a penetrating hole in the shape of a ball; the hole will travel through the convex structure on top of the flagpole and to clamp into the concave under the convex structure thus fix the flag on the flagpole.

6. The structure of flagpole and its holder of claim 5, wherein an opening is along the flagpole at the center part between the concave and convex structure;the opening will make the structure more flexible for the ball shape fixing device to enter or exit.

7. The structure of flagpole and its holder of claim 1, wherein a convex structure is at middle part of the pole to stop bottom side of flag.
